(19) United States
(12) Patent Application Publication
(10) Pub. No.: US 2005/0057034 A1
(43) Pub. Date: Mar. 17, 2005

(54) Consensual sex agreement kit consisting of a book to be used as a guide, book with document enclosure, identification card and method for using same

(76) Inventors: Colleen L. Giles, Columbus, OH (US); La'Mont Carmen, Columbus, OH (US)

Correspondence Address: Colleen L. Giles, 2862 Bretton Woods Dr., Columbus, OH, 43231, US

(21) Appl. No.: 10/930,525

(22) Filed: Aug. 31, 2004

Related U.S. Application Data
(60) Provisional application No. 60/502,166, filed on Sep. 12, 2003.

(51) Int. Cl. B42D 1/00

(52) U.S. Cl. 281/15.1

(57) ABSTRACT

Consensual Sex Agreement Kit, consists of a book, document, I.D. Card for purchaser and method for using same. Book: printed article consisting of sheets secured together. The book comprises a plurality of pages including printing thereon, each of said pages refer to and demonstrate the document associated with the kit. Book with document enclosure: A printed article consisting of sheets secured together where covers are removable by way of perforation comprising of a Release of Liability, Promise Not To Sue, Notice of Satisfactory Completion, Contract Dispute Resolution, Arbitration Procedure, and Checklist of Sexual Activities. Identification Card: Printed matter for use as an identifier, which prevents undesirable use of the document associated with the kit and also prevents misrepresentation of identity of user of the kit. Also provides for entry to members area of kit's associated website.

### CROSS-REFERENCE TO RELATED APPLICATIONS

Claiming the benefit under 35 USC 119(e), a previously filed Provisional Patent. Continuation of application No. 60/502,166 on the date of Sep. 12, 2003.

Cross Referencing the following patents:
1. U.S. Pat. No. 6,126,202 Book publishing kit for children
2. U.S. Pat. No. 6,086,105 Book for packaging activity pieces in an activity kit
3. U.S. Pat. No. 5,989,033 Book kit for a drawing game-fun sky
4. U.S. Pat. No. 5,772,247 Art kit in book form
5. D381,497 Art kit in book form
6. U.S. Pat. No. 5,529,418 Binder for planning calendar/appointment book and kit
7. U.S. Pat. No. 5,397,156 Personalized book kit
8. U.S. Pat. No. 5,284,361 Modular book kit and method of assembly
9. U.S. Pat. No. 5,129,522 Denim book cover and kit for making same
10. U.S. Pat. No. 4,448,443 Continuous form book processing kit

### STATEMENT REGARDING FEDERALLY SPONSORED RESEARCH OR DEVELOPEMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

This invention pertains to human relationships before, during, and after a sexual encounter. There are significant communication problems when it comes to the sexual nature of men and women, what they expect from each other in their interaction with each other before and after a sexual encounter. We seek to enable people discuss their sexual relationships in the hopes of opening lines of communications between them using our method. One part of our method consists of a Consensual Sex Agreement, which lays out the terms of a consensual sexual encounter between willing participants. Our method also consists of a book explaining the method for use of the Agreement, how to fill it out, and what each section inside the Agreement means. It is our hope that by using our method we can decrease the frustration involved in the human sexual encounter as well as stop miscommunication between the parties.

### BRIEF SUMMARY OF THE INVENTION

Consensual Sex Agreement Package consists of a book, Consensual Sex, Volume 1, the actual Consensual Sex Agreement, (contract) and an Identification Card. The book explains the method for using the I.D. Card as well as the Consensual Sex Agreement, how to fill it out, and what each section means. The general idea is to allow willing participants of a sexual encounter to contractually agree to certain terms before a sexual relationship so that there is a better understanding of what each participant expects from the other before a sexual encounter as well as what each other should expect after a sexual encounter. We've also provided for means of Contract Dispute Resolution as well as Arbitration Procedure in the event of contractual misunderstanding. We are providing guidelines of safety by which parties engaged in a sexual encounter may do so without the worry of unspoken debt to one another after the encounter. Currently in the field of human sexuality there is an “assumption” of how each other may or may not act or what the parties may do after a sexual encounter. Using our method there is a contractual understanding of the sexual relationship before and after the encounter.

### BREIF DESCRIPTION OF THE SEVERAL VIEWS OF DRAWING

FIG. 1 is a drawing of the Consensual Sex Agreement Kit's contents containing the two books and the ID card.

FIG. 2 is a drawing of the front cover of the Book, Consensual Sex Volume 1.

FIG. 3 is a drawing of the back cover of the book, Consensual Sex Volume 1.

FIG. 4 is a drawing of the Index page indicating the contents of the book, Consensual Sex Volume 1.

FIG. 5 is a drawing of the saddle stitching of the book, Consensual Sex Volume 1 and means for opening and closing the book.

FIG. 6 is a drawing of the front cover of the book containing the actual Consensual Sex Agreement.

FIG. 7 is a drawing of the back cover of the book containing the actual Consensual Sex Agreement.

FIG. 8 is a drawing of the book containing the actual Consensual Sex Agreement and means for the removal of the agreement for use by the parties.

FIG. 9 is a drawing of the body of the book which contains the actual Consensual Sex Agreement indicating the contents of the book.

FIG. 10 is a drawing of the Consensual Sex Members ID Card used for means of identification of the purchaser.

### DETAILED DESCRIPTION OF THE INVENTION

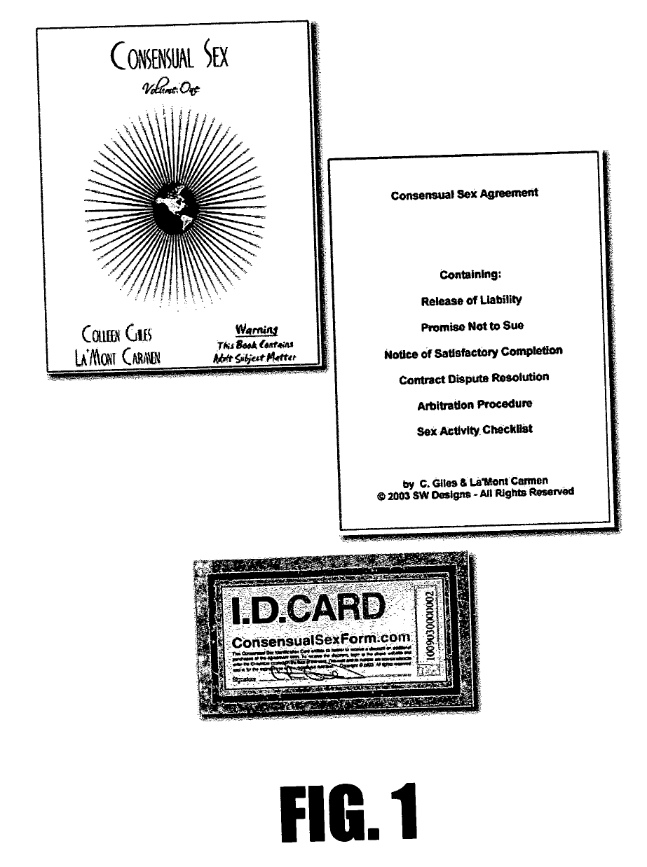

Consensual Sex Agreement Kit, as seen in FIG. 1, consists of a book to be used as a guide, book with document enclosure, identification card, and method for using same.

Book as Seen in FIGS. 1, 2, 3, 4, 5;

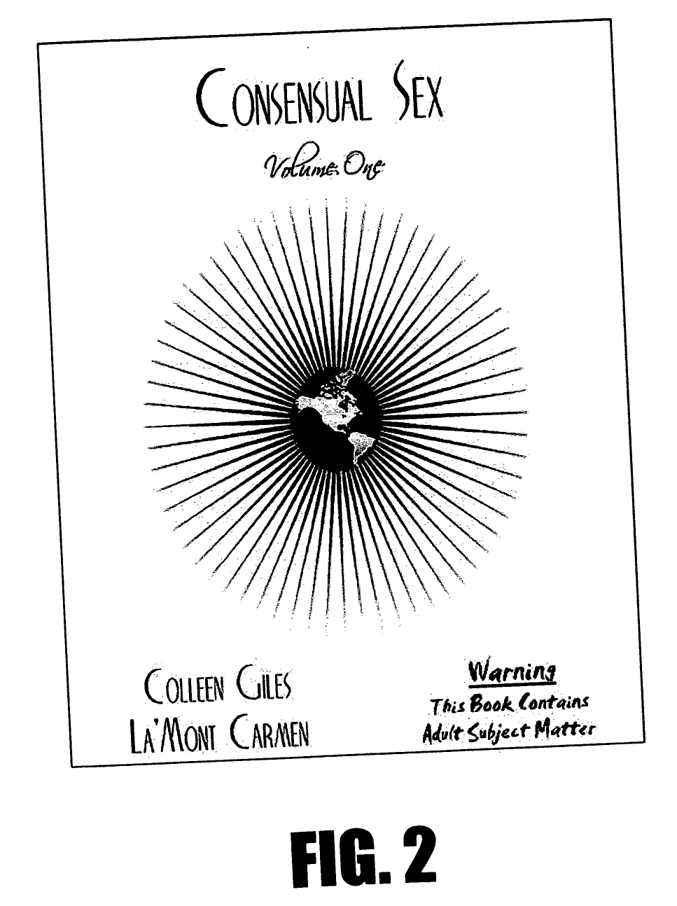

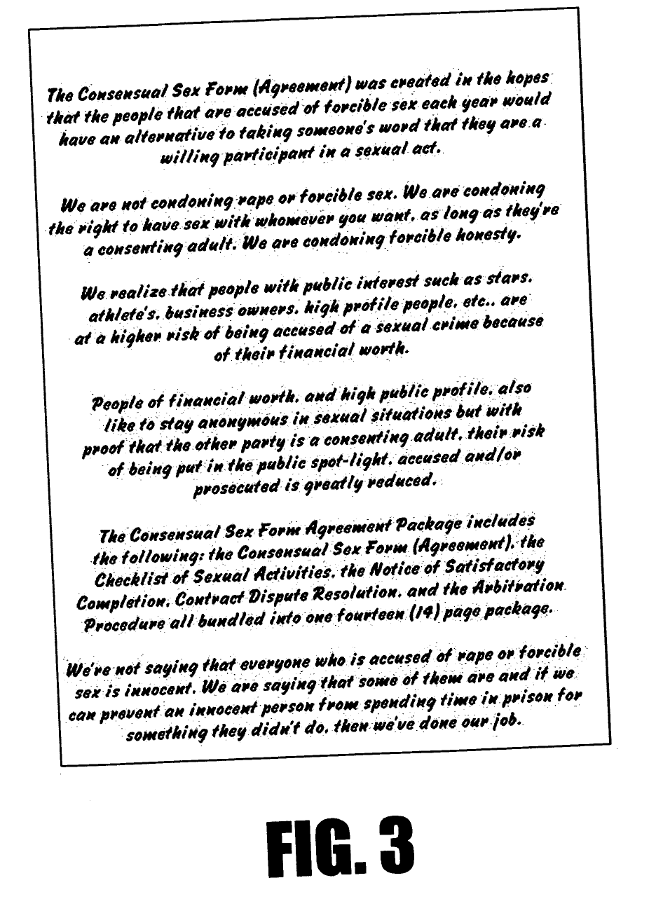

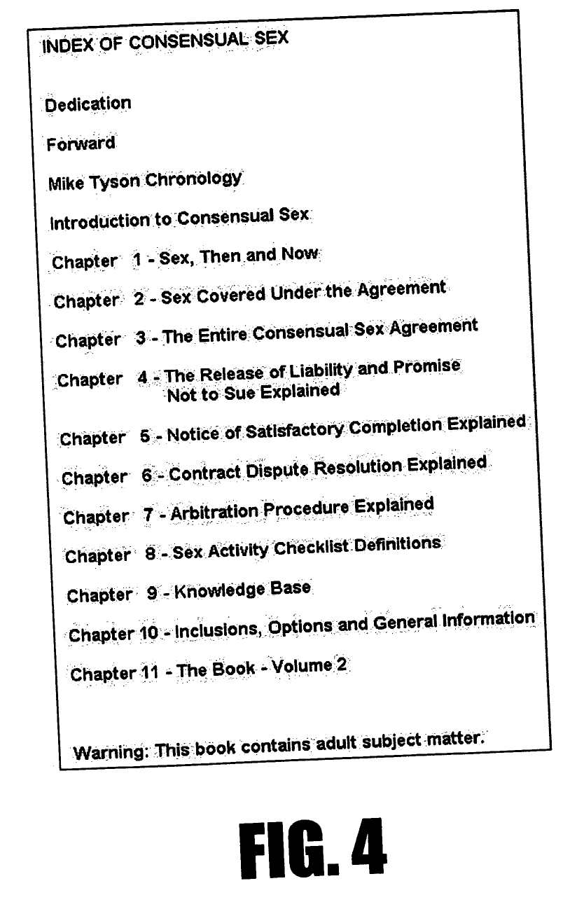

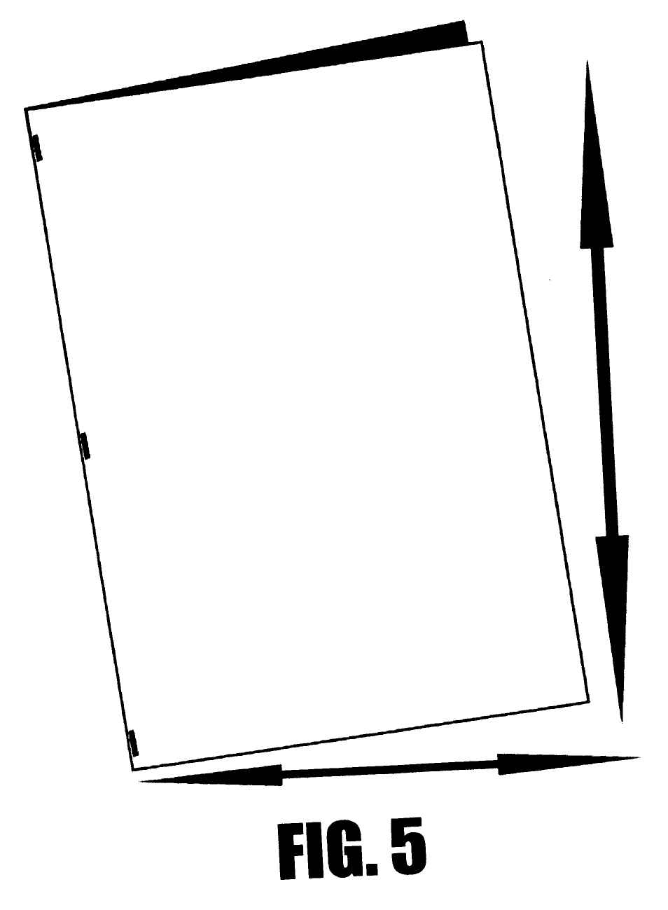

The book, Consensual Sex Volume 1, is printed article consisting of sheets secured together by way of saddle stitching as seen in FIG. 5. The cover as seen in FIG. 2, the back cover as seen in FIG. 3, and a portion of the body of the book as seen in FIG. 4, which is comprised of a plurality of pages including printing thereon. Each of said pages refers to, demonstrates, and should be used as a guide for using the Consensual Sex Agreement, the perforated book, associated with the kit.

Book as Seen in FIGS. 1, 6, 7, 8, 9;

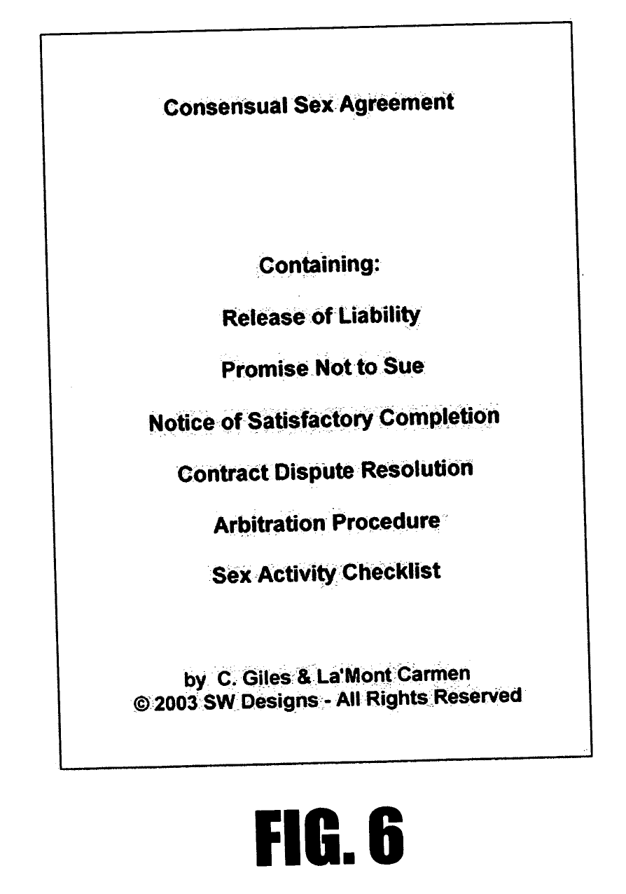

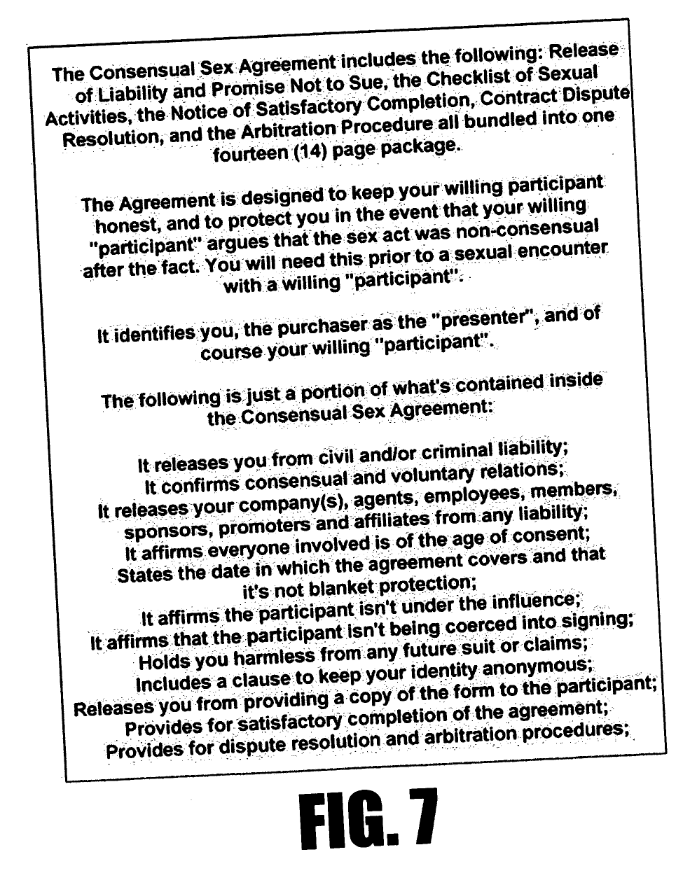

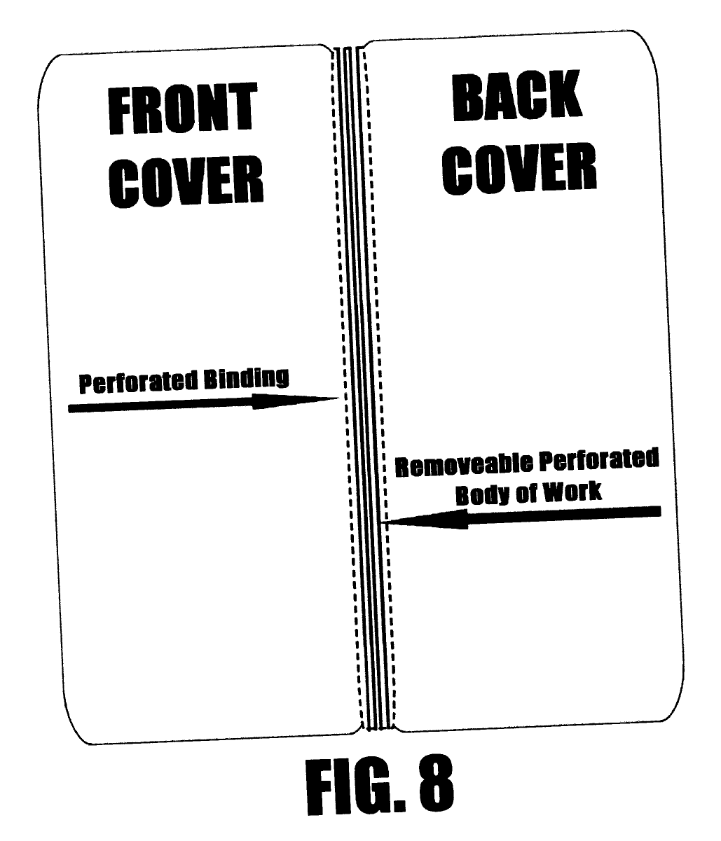

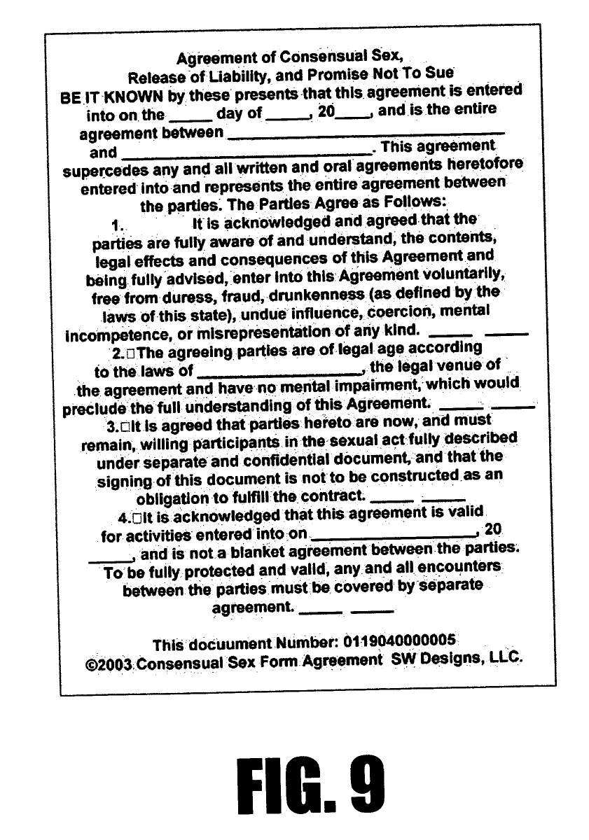

The book, Consensual Sex Agreement, is a printed article consisting of sheets secured together by way of perforation as seen in FIG. 8, with removable front cover as seen in FIG. 6, and removable back cover as seen in FIG. 7. The book as seen in FIG. 9, which is comprised of a plurality of pages including printing thereon, includes a Release of Liability, Promise Not To Sue, Notice of Satisfactory Completion, Contract Dispute Resolution, Arbitration Procedure, and Checklist of Sexual Activities. The front cover and the back cover of the book are meant to be removed thereby revealing the document inside for the parties to read and sign. The book, Consensual Sex Volume 1, should be used along with the Consensual Sex Agreement as a guide for how to fill out the Consensual Sex Agreement.

Identification Card as Seen in FIG. 1, 10;

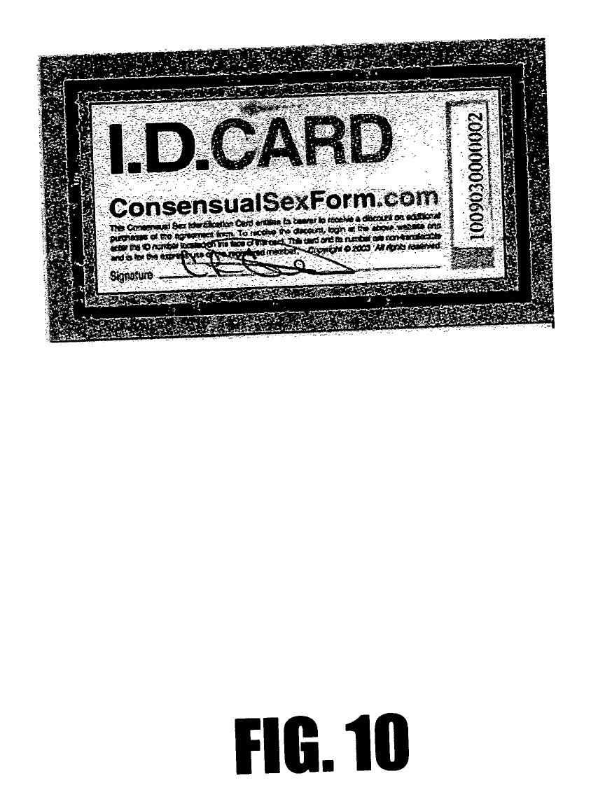

The Identification card, as seen in FIG. 10, is printed matter for use as an identifier, which prevents undesirable use of the document associated with the kit and also prevents misrepresentation of identity of user of the kit. Also provides for entry to members area of kit's associated website.

This invention is a kit and is intended to be used involving interaction between two or more persons for the purpose of contractually communicating the expectations involving a sexual encounter, before, during, and after. This kit provides for a contractual understanding of the sexual encounter for not only the purchaser of the kit, but the other interacting party(s). By using the kit's defined guidelines before a sexual encounter, there is prevention of false communication, miscommunication, and the inevitable apprehensiveness, before and after, associated with the sexual encounter.

1. Book 1, Consensual Sex Volume 1, consisting of;
a front cover and a back cover;
a set of pages bound by a binding means along a common edge to said front and back cover by way of saddle stitching;
book 1 as defined in claim 1 wherein the set of pages comprises of 48 pages, size 8½×11;
book 1 as defined in claim 1 wherein the set of pages comprises of the related subject matter of claim 2 and is to be used as a demonstration and/or guide to same;

2. Book 2, Consensual Sex Agreement book with document enclosure comprising of:
a front cover and a back cover;
a set of pages bound by a binding means along a common edge to said front and back cover, which are removable by way of perforation of the body of the book;
book 2 with document enclosure as defined in claim 2 wherein the set of pages comprises of 14 pages, size 8½×11;
book 2 with document enclosure as defined in claim 2 wherein the set of pages comprises of the related subject matter of claim 1 wherein the subject matter involves the interaction between two or more persons;

3. An identification card for use as an identifier exclusive of the subject matter of claim 2, which is intended to conceal information, prevent or detect fraud, or prevent or detect undesirable use of the subject matter in claim 2.
